(19) United States
(12) Patent Application Publication
(10) Pub. No.: US 2015/0237292 A1
(43) Pub. Date: Aug. 20, 2015

(54) PROJECTION SYSTEM AND PROJECTION METHOD THEREOF

(71) Applicants: Wen-Wei Tsai, Hsin-Chu (TW); Tung-Yi Lu, Hsin-Chu (TW); Chun-Chin Chang, Hsin-Chu (TW); Shun-Tai Chen, Hsin-Chu (TW); Kun-Liang Jao, Hsin-Chu (TW)

(72) Inventors: Wen-Wei Tsai, Hsin-Chu (TW); Tung-Yi Lu, Hsin-Chu (TW); Chun-Chin Chang, Hsin-Chu (TW); Shun-Tai Chen, Hsin-Chu (TW); Kun-Liang Jao, Hsin-Chu (TW)

(73) Assignee: CORETRONIC CORPORATION, Hsin-Chu (TW)

(21) Appl. No.: 14/510,117

(22) Filed: Oct. 9, 2014

(30) Foreign Application Priority Data
Feb. 19, 2014 (TW) 103105542

(51) Int. Cl. H04N 5/74; G06F 3/041; G03B 21/20; G03B 21/00; G03B 21/60

(52) U.S. Cl. CPC H04N 5/74; G03B 21/005; G03B 21/60; G03B 21/208; G06F 3/041

(57) ABSTRACT

A projection system and a projection method thereof are provided. An illumination beam is outputted through a light-uniforming element which an aspect ratio of a light emitting terminal conforms to an ultrawide projection ratio. A host is instructed by an extended display identification data to provide an image signal corresponding to the ultrawide projection ratio. A light valve is configured to a mode corresponding to the ultrawide projection ratio. The light valve is controlled to convert the illumination beam into an image beam according to the image signal.

### CROSS-REFERENCE TO RELATED APPLICATION

This application claims the priority benefit of Taiwan application serial no. 103105542, filed on Feb. 19, 2014. The entirety of the above-mentioned patent application is hereby incorporated by reference herein and made a part of this specification.

### BACKGROUND

1. Technical Field

The invention generally relates to a display apparatus, and more particularly, to a projection system and a projection method thereof.

2. Related Art

Currently, two or more than two projectors are commonly employed to implement a projection of ultrawide screen (such as 16:6) in a blending manner. As such, a switching box is additionally provided to divide an image signal, and then the divided image signals are respectively transmitted to the projectors so as to blend the projection image. Due to the differences in color temperature or brightness exit between the images projected from the projectors for blending the projection image, one of the projectors has to be taken as an adjustment basis for the projected frames, such that the chrominance of the blended projected frame can be consistent. However, by this way, the quality of the projected frames has to be sacrificed, and each time as splicing the projection image is performed, additional devices are required to assist calibrating the blended image, which results in a waste of manpower and time.

Patent applications related to a projection system are listed as follows: U.S. Publication No. 2012/0206695, U.S. Publication No. 2013/0290416, U.S. Pat. No. 7,667,815, U.S. Pat. No. 8,550,913, China Publication No. 100383602 and China Publication No. 201984452.

### SUMMARY

The invention is directed to a projection system and a projection method thereof, which are capable of providing projection frames without being compressed and distorted.

Other objectives and advantages of the invention should be further indicated by the disclosures of the invention, and omitted herein for simplicity.

To achieve the above-mentioned or other objectives, one embodiment of the invention provides a projection system including a projection surface and a projection device, in which the projection device is adapted to couple to a host. The projection device includes a light source, a light valve, a light-uniforming element, a storage unit and a control unit. The light source is configured to provide an illumination beam. The light valve is disposed on a transmission path of the illumination beam and has a light receiving surface, in which the light receiving surface converts the illumination beam into an image beam to project onto a projection surface, so as to form an image frame. The light-uniforming element is disposed on the transmission path of the illumination beam and is located between the light source and the light valve. The light-uniforming element has a light incident terminal and a light emitting terminal. The illumination beam enters from the light incident terminal to the light-uniforming element and departs the light-uniforming element from the light emitting terminal, in which an aspect ratio of the light emitting terminal conforms to a projection ratio. The storage unit stores an extended display identification data and a resolution mode lookup table. The control unit is coupled to the light valve and the storage unit, and provides the extended display identification data (EDID) to the host so as to instruct the host to provide an image signal corresponding to the projection ratio, configures the light valve to a mode corresponding to the projection ratio according to the resolution mode lookup table and controls the light valve to convert the illumination beam into the image beam according to the image signal. The control unit further configures the light valve to the mode corresponding to the projection ratio according to the resolution mode lookup table, so that an ultrawide image frame conforms to the projection ratio.

In an embodiment of the invention, the projection ratio is between 2.3:1 and 2.7:1.

In an embodiment of the invention, the light-uniforming element is an integration rod or a lens array.

In an embodiment of the invention, when the light valve is configured to the mode corresponding to the projection ratio, the control unit disables one part of the regions of the light receiving surface, so that the other part of the regions of the light receiving surface without being disabled conform to the projection ratio, in which the other part of the regions of the light receiving surface without being disabled is configured to receive the illumination beam from the light emitting terminal.

In an embodiment of the invention, an area of the light incident terminal of the integration rod is greater than or equal to an area of the light emitting terminal.

In an embodiment of the invention, the projection system further includes a touch module, in which the touch module includes at least one detecting light source and a light sensing unit. The detecting light source is configured to emit a detecting beam to detect the projection surface. The light sensing unit is adapted to couple to the host and senses a reflect light of the detecting beam reflected by a touch object, and the host determines a touch location of the touch object according to the reflect light.

In an embodiment of the invention, the projection system further includes a light emitting unit and an invisible light sensing unit, in which the light emitting unit simultaneously emits a visible light and an invisible light to form a light spot on the projection surface. The invisible light sensing unit is adapted to couple to the host and senses the invisible light, and the host determines a location of the light spot according to a sensing result of the invisible light sensing unit.

In an embodiment of the invention, projection device is further connected to a cloud server through a network interface.

In an embodiment of the invention, the projection surface is a screen, and the screen includes a Fresnel lens film or a smart glass.

In an embodiment of the invention, the light source includes a light-emitting diode, a laser light source or a high-pressure mercury lamp.

In an embodiment of the invention, the light valve is a digital micromirror device (DMD) or a liquid crystal on silicon (LCOS) panel.

In an embodiment of the invention, the projection device is spaced from the projection surface by a distance of 30-50 cm, and the image frame projected by the projection device is above 130 inches.

The invention provides a projection method of a projection system, which includes the following steps. An extended display identification data is provided to a host, so as to instruct the host to provide an image signal corresponding to a projection ratio. A light valve is configured to a mode corresponding to the projection ratio according to a resolution mode lookup table. A light-uniforming element is provided to be disposed on a transmission path of an illumination beam, in which the light-uniforming element has a light incident terminal and a light emitting terminal

The illumination beam enters from the light incident terminal to the light-uniforming element and departs the light-uniforming element from the light emitting terminal, in which an aspect ratio of the light emitting terminal conforms to the projection ratio. A light valve is controlled according to the image signal so as to convert the illumination beam departing the light-uniforming element into an image beam. The image beam is projected to a projection surface so as to form an image frame which conforms to the projection ratio.

In an embodiment of the invention, the projection ratio is between 2.3:1 and 2.7:1.

In an embodiment of the invention, the light valve has a light receiving surface, in which the light receiving surface converts the illumination beam into the image beam. When the light valve is configured to the mode corresponding to the projection ratio, one part of regions of the light receiving surface is disabled, so that the other part of regions of the light receiving surface without being disabled conforms to the projection ratio.

In an embodiment of the invention, the light-uniforming element is an integration rod or a lens array.

In an embodiment of the invention, an area of the light incident terminal of the integration rod is greater than or equal to an area of the light emitting terminal.

According to the above descriptions, in the embodiments of the invention, the illumination beam is outputted through the light-uniforming element which the aspect ratio of the light emitting terminal conforms to the projection ratio, and the light valve is simultaneously configured to the mode corresponding to the projection ratio through the extended display identification data instructing the host to provide the image signal corresponding to the projection ratio, so that the light valve converts the illumination beam into the image beam capable of projecting the projection frame conformed to the projection ratio, thereby providing the projection frame without being compressed and distorted, and employing one single projection device to project out the image frame size that is conventionally achieved by two projection devices.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a projection system according to an embodiment of the invention.

FIG. 2A is a schematic diagram illustrating a projection system according to another embodiment of the invention.

FIG. 2B is a schematic diagram illustrating a projection system according to another embodiment of the invention.

FIG. 2C is a schematic diagram illustrating a projection system according to another embodiment of the invention.

FIG. 3 is a flowchart diagram illustrating a projection method of a projection system according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above-mentioned or other relevant technical principles and the features and effects thereof are clearly depicted together with the accompanying drawings in the following depicted embodiments. Note that some of expression words hereinafter regarding direction or orientation, such as ‘up’, ‘down’, ‘left’, ‘right’, ‘front’, ‘behind’, and the like, are to describe, not to limit, the invention.

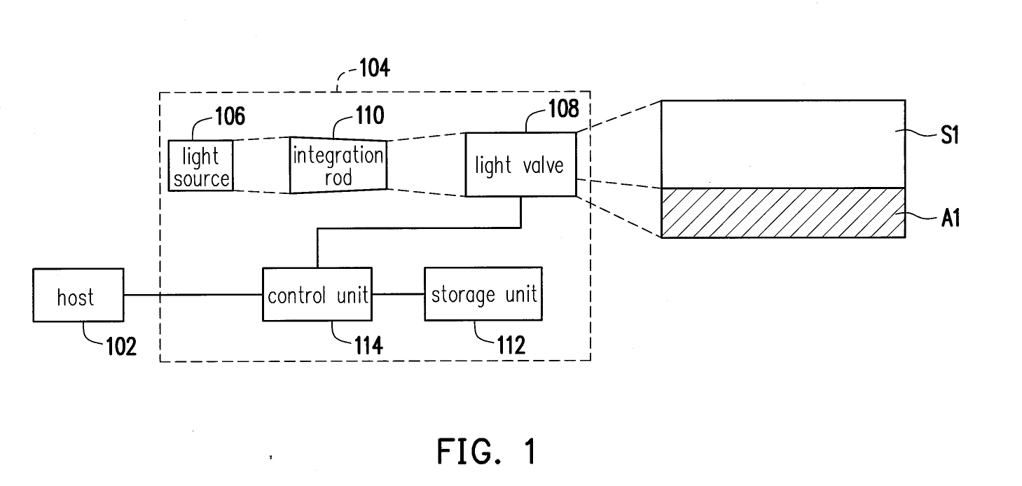

FIG. 1 is a schematic diagram illustrating a projection system according to an embodiment of the invention. Referring to FIG. 1, the projection system includes a projection surface S1 and a projection device 104. The projection device 104 may include a light source 106, a light valve 108, an integration rod 110, a storage unit 112 and a control unit 114, in which the control unit 114 is coupled to the light valve 108 and the storage unit 112. The storage unit 112 may be configured to store an extended display identification data (EDID), in which the extended display identification data may include the data such as the highest resolution, the scan frequency, the manufacture's name and the serial number of the projector device 104. The projection device 104 is adapted to couple to the host 102, in which the host 102 may be an electronic device capable of providing image information such as a computer, a tablet PC or a mobile phone, etc. When the projection device 104 and the host 102 are connected to each other, the host 102 may request the projection device 104 to provide the extended display identification data. The control unit 114 in the projection device 104 may provide the extended display identification data stored in the storage unit 112 to the host 102, so as to inform the host 102 that the image frame ratio (or the resolution) of the projection device 104 to be projected, such that the host 102 provides an image signal corresponding to the image frame ratio to be projected. For example, in the embodiment, the projection device 104 is configured to project an ultrawide image frame, and the ultrawide image frame is an image frame with an ultrawide projection ratio, in which the ultrawide projection ratio may be between 2.3:1 and 2.7:1. For instance, the preferable ultrawide projection ratio may be 16:6 or 21:9, although the invention is not limited thereto. The host 102 may provide an image signal with the ultrawide projection ratio to the control unit 114 according to the extended display identification data from the control unit 114.

Moreover, the light source 106 is configured to provide an illumination beam, in which the light source 106 may be a light-emitting diode, a laser light source or a high-pressure mercury lamp to implement, although the invention is not limited thereto. The integration rod 110 is disposed on a transmission path of the illumination beam, and is located between the light source 106 and the light valve 108. The integration rod 110 has a light incident terminal and a light emitting terminal. The integration rod 110 may receive the illumination beam from the light source 106 through the light incident terminal thereof, and output the illumination beam from the light emitting terminal thereof, in which the area of the light incident terminal of the integration rod 110 is greater than the area of the light emitting terminal, and an aspect ratio of the light emitting terminal conforms to the ultrawide projection ratio. As such, the illumination beam can be more focused, thereby enhancing the projection quality. It should be noted that the area of the light incident terminal of the integration rod 110 in other embodiments may be equal to the area of the light emitting terminal, which is not limited to the embodiment.

The light valve 108 may be a digital micromirror device (DMD) or a liquid crystal on silicon (LCOS) panel, for instance, and is disposed on the transmission path of the illumination beam. The illumination beam after being outputted from the light emitting terminal of the integration rod 110 incidents to the light valve 108. The light valve 108 has a light receiving surface. The control unit 114 may control the light receiving surface of the light valve 108 according to the image signal provided by the host 102, in which the light receiving surface of the light valve 108 may convert the illumination beam incidented to the light receiving surface into an image beam, so that the image beam is projected onto the projection surface S1 to form the ultrawide image frame. The projection surface S1 may be a screen, a table surface or a wall, in which the screen includes a Fresnel lens film which is capable of guiding a projection beam to the viewer to increase the color enhancement and the contrast, or the projection surface may a screen S1 with an eraser feature. The screen S1 may also be a smart glass which is capable of appearing in a transparent or a fog-white state according to different applied voltages, so as to serve as a projection surface for projecting. In other words, the projection surface S1 may be a reflective or transmissive screen.

Moreover, the storage unit 112 may also store the resolution mode lookup table, where the resolution mode lookup table is to store the ultrawide image resolutions, such as a resolution of 1920×720, 1280×550 or 2560×1080, although the invention is not limited thereto. The required resolution may be specified according to the manufacture. When the control unit 114 controls the light receiving surface of the light valve 108 according to the image signal to perform the conversion of the illumination beam, a mode corresponding to the ultrawide projection ratio may be looked up according to the resolution mode lookup table stored in the storage unit 112, and the light valve 108 is configured to the mode corresponding to the ultrawide projection ratio (or the resolution) so as to ensure the format of the image signal provided by the host 102 is compatible with the projection device 104. When the light valve 108 has been configured to the mode corresponding to the ultrawide projection ratio, the control unit 114 disables one part of the regions of the light receiving surface in the light valve 108, so that the other part of the regions of the light receiving surface without being disabled conforms to the ultrawide projection ratio, where the other part of the regions of the light receiving surface without being disabled may be configured to receive the illumination beam from the light emitting terminal of the integration rod 110. Regarding the disablement of the control unit 114, in one example, as the light valve is the digital micromirror device, electric signals are employed to control the digital micromirrors in the part of the regions of the light receiving surface not to be actuated, such that the illumination beam may not be projected to the projection surface through a wide-angle lens; and in another example, as the light valve is the liquid crystal on silicon panel, electric signals may also be employed for the disablement of the control unit 114, so as to control the liquid crystal molecules in the part of the regions of the light receiving surface in the light valve, such that the illumination beam is incapable of penetrating through or being reflected to form the image beam. As such, through disabling the part of the regions of the light receiving surface in the light valve 108, the image beam corresponding to the regions A1 (that is, the oblique-line region of FIG. 1) without projection may be shielded, so as to ensure the ratio of the projection frame is complied with the ultrawide projection ratio.

As described above, the illumination beam is outputted through the integration rod which the aspect ratio of the light emitting terminal conforms to the ultrawide projection ratio, and the light valve is simultaneously configured to the mode corresponding to the ultrawide projection ratio through the extended display identification data to instruct the host to provide the image signal corresponding to the ultrawide projection ratio, so that the light valve according to the image signal converts the illumination beam into the image beam capable of projecting the ultrawide projection frame conformed to the ultrawide projection ratio. In the invention, the projection device may be equipped with an ultra-short focus wide-angle projection lens (not shown), namely, an ultra-short focus wide-angle projector, such that the image beam may be projected onto the projection surface S1 to form the ultrawide image frame, and a throw ratio of the projection device may be lower than 0.4 (for instance, 0.35, 0.25, 0.18), where the throw ratio is defined as a ratio of a distance between the projection device and the projection surface relative to a width of a projection frame on the projection surface. For example, a projection frame with an original resolution of 1920×1080 and a projection frame ratio of 16:9 is performed through the projection system of the aforementioned embodiment, so as to project out an ultrawide projection frame with a resolution of 1920×720 and a projection frame ratio of 16:6, or to project out an ultrawide projection frame with a resolution of 1920×822, 2560×1080, 1280×550 and a projection frame ratio of 21:9. Therefore, one single projector may also project an ultrawide projection frame that is 130 inches (the projection frame ratio 16:6) to 150 inches (the projection frame ratio 21:9) or above, when the projector is spaced from the projection surface within a distance of 30 cm to 50 cm, so as to avoid the problems of the conventional techniques such as sacrificing brightness and wasting the adjustment times due to splicing from plural projectors and the image distortion caused by image compression.

In another embodiment of the invention, the light valve may be the liquid crystal on silicon panel, and is equipped with a lens array to sever as a light-uniforming element for providing the illumination beam, where the lens array has the same function as that of the integration rod, and has a light incident terminal and a light emitting terminal equivalent to that of the integration rod. In brief, an aspect ratio of the light emitting terminal of the lens array conforms to the projection ratio, and the lens array is configured to output the illumination beam onto the liquid crystal on silicon panel.

The projection system capable of projecting the ultrawide image frame without being compressed or distorted, described above, may be employed in various applications. For example, the projection system of the invention may be employed to project ultrawide projection frames at places such as station halls, business exhibition venues. It is unnecessary to use multiple projectors to blend the projection images, only one single projection device may be used to achieve the same effect. Concurrently, referring to FIG. 1, through a multi-window function of the host 102, the information of different windows may be provided to the control unit 114 of the projection device 104 so as to achieve the ultrawide projection window frame. For another example, when the projection system is used at home to enjoy movies, a same level of visual effect with that of cinema is reached to achieve better user experience. Moreover, the projection system may be disposed behind the projection surface to serve as a digital signage in a rear projection manner, and an ultrawide projection frame is projected onto the projection surface in order to achieve the advertising effect. For another example, the ultrawide image frames projected by the projection system are utilized to display the video game frames, so that the video game frames are more vivid, and the image size is greater, and in case of a multiplayer game, the problem of image distortion may not be arisen, so that the game can be more fun in competition. In some embodiments, the projection device may also be connected to a cloud server (cloud network) 208 through a network interface, in which the network interface may be a wired network interface or a wireless network interface, for instance. In this way, when the projection system is used for briefing, the projected frames may be transmitted to other hosts such as the portable devices of people participating the meeting (for instance, the mobile phones, tablet PCs, notebook computers, etc.) through the cloud server, so as to facilitate the proceeding of the meeting smoothly. Alternatively, an Android OS or iSO platform may be installed in the projection device, so as to directly connect with the portable devices (for instance, the mobile phones, tablet PCs, notebook computers, etc.) in a wireless/wired manner. In addition, the divided videoconference frames from the persons remotely participated may also be projected onto the projection surface during the meeting, and the projection device may be utilized to simultaneously project out the information that is conventionally produced into two slides, so that the information such as the product development schedule and the technology development process may be clearly illustrated, which facilitates the communication and the discussion with the participants in a more intuitive manner.

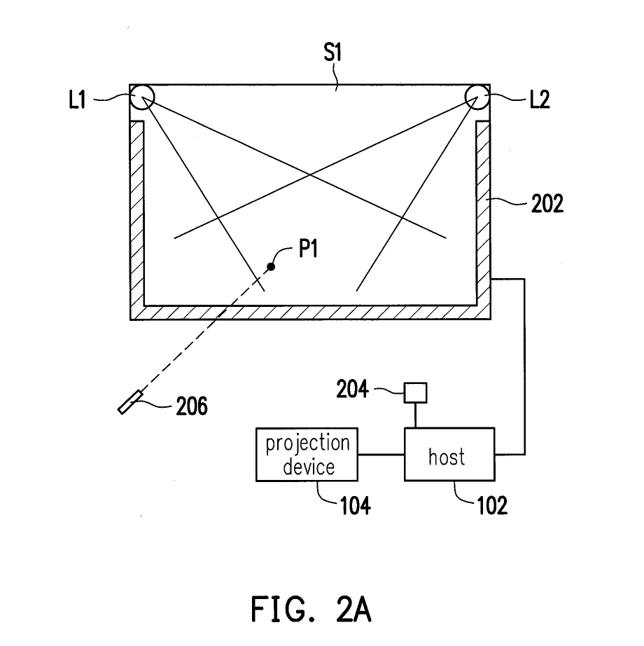

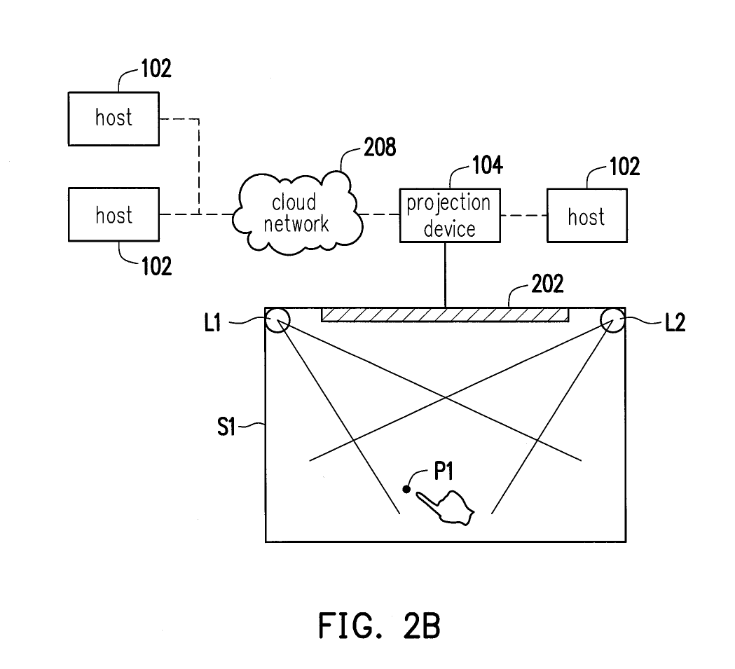

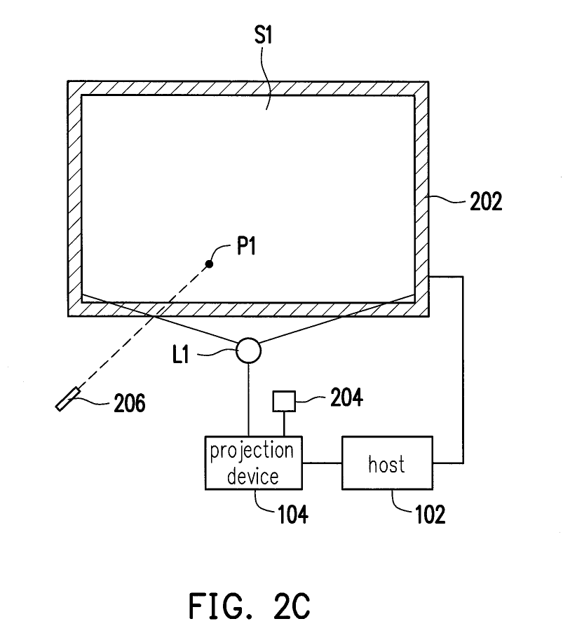

FIG. 2A is a schematic diagram illustrating a projection system according to another embodiment of the invention. Referring to FIG. 2A, the projection system of the embodiment further includes a touch device, in which the touch device includes detecting light sources L1, L2 and a light sensing unit 202. The detecting light sources L1 and L2 are configured to emit detecting beams to detect the projection surface S1. The light sensing unit 202 is coupled to the host 102. In the embodiment, the light sensing unit 202 is located at the sidewalls of the projection surface S1 to form a U-shape disposition. The light sensing unit 202 may sense the light shielded by a touch object (for instance, a finger, a stylus or other objects capable of blocking or reflecting the detection beams) or sense the reflect light of the detecting beams reflected by the touch object, and the host 102 is able to determine a touch location of the touch object according to a sensing result of the light sensing unit 202. It should be noted that the quantity of the detecting light sources is not limited to the embodiment. In other embodiments, a single detecting light source or more detecting light sources may be employed to implement the detection of the projection surface S1.

The projection system of the embodiment further includes a light emitting unit 206, which may be a laser pen capable of emitting a visible light, for instance. The visible light emitted from the light emitting unit 206 forms a light spot P1 on the projection surface S1, and thus the viewer is aware of the location that the light emitting unit 206 points at. As such, even the user uses the light emitting unit 206 to remotely control, other viewers may also be able to see the location and the movement of the light spot P1, thereby facilitating people to discuss collaboratively, in which the aforementioned detecting beams may be an infrared light or other invisible lights, and the light sensing unit 202 may be an infrared camcorder or other sensors capable of correspondingly detecting the invisible light, for instance.

FIG. 2B is a schematic diagram illustrating a projection system according to another embodiment of the invention. Referring to FIG. 2B, the projection system of the embodiment further includes a touch device, in which the touch device includes detecting light sources L1, L2 and a light sensing unit 202, and moreover, the projection device may be connected to the cloud network 208 in a wired/wireless manner, so as to transfer image information with other remote hosts 102 afterwards. The detecting light sources L1 and L2 are configured to emit detecting beams to detect the projection surface S1. The light sensing unit 202 is coupled to the host 102, in which the light sensing unit 202 in the embodiment is located at a sidewall of the projection surface S1. The light sensing unit 202 may sense the light shielded by a touch object (for instance, a finger, a stylus or other objects capable of blocking or reflecting the detection beams) or sense the reflect light of the detecting beams reflected by the touch object, and the host 102 is able to determine a touch location of the touch object according to a sensing result of the light sensing unit 202. It should be noted that the quantity of the detecting light sources is not limited to the embodiment. In other embodiments, a single detecting light source or more detecting light sources may be employed to implement the detection of the projection surface S1.

FIG. 2C is a schematic diagram illustrating a projection system according to another embodiment of the invention. Referring to FIG. 2C, the projection system of the embodiment further includes a touch device, in which the touch device includes a detecting light source L1 and a invisible light sensing unit 204, and moreover, the projection device 104 is coupled to the host 102 to transfer the image information. The detecting light source L1 is configured to emit an invisible light curtain such as an infrared (IR) laser curtain, so as to cover the surface of the projection surface S1. The invisible light sensing unit 204 is coupled to the projection device 104, in which the invisible light sensing unit 204 may be located beside the projection device 104 or may be integrated in the projection device 104. In another embodiment, the invisible light sensing unit 204 may also be coupled to the host 102 directly. The invisible light sensing unit 204 may sense the light shielded by a touch object (for instance, a finger, a stylus or other objects capable of blocking or reflecting the detection beams) or sense the reflect light of the detecting beams reflected by the touch object, and the host 102 is able to determine a touch location of the touch object according to a sensing result of the invisible light sensing unit 204.

Additionally, the projection system of the embodiment further includes a light emitting unit 206, which may be a laser pen capable of emitting a coaxial dual-wavelength light, namely, capable of emitting a visible light and an invisible light simultaneously, for instance. The visible light emitted from the light emitting unit 206 forms a light spot P1 on the projection surface S1, and thus the viewer is aware of the location that the light emitting unit 206 points at. On the other hand, The invisible light emitted from the light emitting unit 206 forms a light spot (where its location is same as that of the light spot P1) on the projection surface S1, and such light spot may be detected by the invisible light sensing unit 204. The host 102 is able to determine a location of the light spot P1 according to a sensing result of the invisible light sensing unit 204, and to execute a corresponding operation (for instance, to display a moving trajectory of the light spot P1 on the projection frame, or to execute a corresponding touch operation according to a position of the light spot P1). As such, even the user uses the light emitting unit 206 to remotely control, other viewers may also be able to see the location and the movement of the light spot P1, thereby facilitating people to discuss collaboratively, in which the aforementioned detecting beams and the invisible light may be an infrared light or other invisible lights, and the invisible light sensing unit 204 may be an infrared camcorder or other sensors capable of correspondingly detecting the invisible light, for instance.

By this way, the projection system has a touch function, which further enriches the usage of the projection system. For example, the teacher and the students may directly perform touch operations on the projection surface in a classroom, such as allowing the teacher to teach and demonstrate exercises or allowing the students to answer, so as to proceed the teaching activity in a more intuitive and convenient way. For another example, when such projection system is applied to a store window, the catalog and the design of products may be provided for the potential consumers to click and view, thereby providing a more convenient service for the consumers.

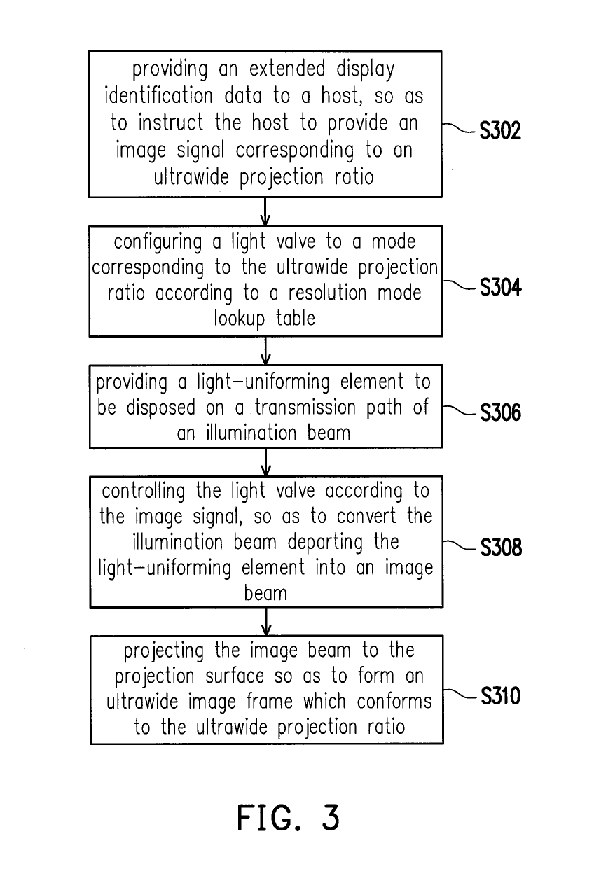

FIG. 3 is a flowchart diagram illustrating a projection method of a projection system according to an embodiment of the invention. Referring to FIG. 3, the projection method summarized the aforementioned projection system may include the following steps. Firstly, an extended display identification data is provided to a host, so as to instruct the host to provide an image signal corresponding to an ultrawide projection ratio (step S302). Subsequently, a light valve is configured to a mode corresponding to the ultrawide projection ratio according to a resolution mode lookup table (step S304). Then, a light-uniforming element is provided to be disposed on a transmission path of an illumination beam (step S306), in which the light-uniforming element has a light incident terminal and a light emitting terminal, where the light-uniforming element may be an integration rod or a lens array, for instance, an area of the light incident terminal of the integration rod is greater than or equal to an area of the light emitting terminal, the illumination beam enters from the light incident terminal to the light-uniforming element and departs the light-uniforming element from the light emitting terminal, and an aspect ratio of the light emitting terminal conforms to the ultrawide projection ratio. The ultrawide projection ratio may be between 2.3:1 and 2.7:1, for instance. Afterwards, the light valve is controlled according to the image signal so as to convert the illumination beam departing from the light-uniforming element into an image beam (step S308), in which the light valve has a light receiving surface, where the light receiving surface converts the illumination beam into the image beam. When the light valve is configured to the mode corresponding to the projection ratio, one part of regions of the light receiving surface is disabled, so that the other part of regions of the light receiving surface without being disabled conform to the projection ratio. Finally, the image beam is projected to the projection surface so as to form an image frame which conforms to the projection ratio (step S310).

In summary, in the embodiments of the invention, the illumination beam is outputted through the light-uniforming element which the aspect ratio of the light emitting terminal conforms to the projection ratio, the light valve is simultaneously configured to the mode corresponding to the projection ratio through the extended display identification data instructing the host to provide the image signal corresponding to the projection ratio, and the light valve is controlled according to the image signal so as to convert the illumination beam into the image beam capable of projecting the projection frame conformed to the projection ratio, thereby providing the projection frame without being compressed and distorted.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching and are not used to limit the range of the claims of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. The “first”, the “second”, etc. mentioned in the specification and the claims are merely used to name the elements and should not be regarded as limiting the upper or lower bound of the number of the components/devices.

What is claimed is:

1. A projection system, comprising:
a projection surface; and
a projection device, adapted to couple to a host, and the projection device comprising:
a light source, providing an illumination beam;
a light valve, disposed on a transmission path of the illumination beam and having a light receiving surface, wherein the light receiving surface converts the illumination beam into an image beam to project onto the projection surface, so as to form an image frame;
a light-uniforming element, disposed on the transmission path of the illumination beam and located between the light source and the light valve, wherein the light-uniforming element has a light incident terminal and a light emitting terminal, the illumination beam enters from the light incident terminal to the light-uniforming element and departs the light-uniforming element from the light emitting terminal, and an aspect ratio of the light emitting terminal conforms to an ultrawide projection ratio;
a storage unit, storing an extended display identification data and a resolution mode lookup table; and
a control unit, coupled to the light valve and the storage unit, and adapted to provide the extended display identification data to the host so as to instruct the host to provide an image signal corresponding to the projection ratio, and to configure the light valve to a mode corresponding to the projection ratio according to the resolution mode lookup table and to control the light valve to convert the illumination beam into the image beam according to the image signal, wherein the control unit further configures the light valve to the mode corresponding to the projection ratio according to the resolution mode lookup table, so that the image frame conforms to the projection ratio.

2. The projection system according to claim 1, wherein the projection ratio is between 2.3:1 and 2.7:1.

3. The projection system according to claim 1, wherein when the light valve is configured to the mode corresponding to the projection ratio, the control unit disables one part of regions of the light receiving surface, so that the other part of regions of the light receiving surface without being disabled conforms to the projection ratio, where the other part of the regions of the light receiving surface without being disabled is configured to receive the illumination beam from the light emitting terminal.

4. The projection system according to claim 1, wherein the light-uniforming element is an integration rod or a lens array.

5. The projection system according to claim 4, wherein an area of the light incident terminal of the integration rod is greater than or equal to an area of the light emitting terminal.

6. The projection system according to claim 1, further comprising:
a touch module, and the touch module comprising:
at least one detecting light source, emitting a detecting beam to detect the projection surface; and
a light sensing unit, adapted to couple to the host, and sensing a reflect light of the detecting beam reflected by a touch object, wherein the host determines a touch location of the touch object according to the reflect light.

7. The projection system according to claim 1, further comprising:
a light emitting unit, simultaneously emitting a visible light and an invisible light to form a light spot on the projection surface; and
an invisible light sensing unit, adapted to couple to the host, and sensing the invisible light, wherein the host determines a location of the light spot according to a sensing result of the invisible light sensing unit.

8. The projection system according to claim 1, wherein the projection device is further connected to a cloud server through a network interface.

9. The projection system according to claim 1, wherein the projection surface is a screen, and the screen comprises a Fresnel lens film or a smart glass.

10. The projection system according to claim 1, wherein the light valve is a digital micromirror device or a liquid crystal on silicon panel.

11. The projection system according to claim 1, wherein the projection device is spaced from the projection surface by a distance of 30-50 cm, and the image frame projected by the projection device is above 130 inches.

12. A projection method of a projection system, comprising:
providing an extended display identification data to a host, so as to instruct the host to provide an image signal corresponding to a projection ratio;
configuring a light valve to a mode corresponding to the projection ratio according to a resolution mode lookup table;
providing a light-uniforming element to be disposed on a transmission path of an illumination beam, wherein the light-uniforming element has a light incident terminal and a light emitting terminal, the illumination beam enters from the light incident terminal to the light-uniforming element and departs the light-uniforming element from the light emitting terminal, and an aspect ratio of the light emitting terminal conforms to the projection ratio;
controlling the light valve to convert the illumination beam departing from the light-uniforming element into an image beam according to the image signal; and
projecting the image beam to a projection surface to form an image frame conformed to the projection ratio.

13. The projection method of the projection system according to claim 12, wherein the projection ratio is between 2.3:1 and 2.7:1.

14. The projection method of the projection system according to claim 12, wherein the light valve has a light receiving surface, the light receiving surface converts the illumination beam into the image beam, and when the light valve is configured to the mode corresponding to the projection ratio, one part of regions of the light receiving surface is disabled, so that the other part of regions of the light receiving surface without being disabled conform to the projection ratio.

15. The projection method of the projection system according to claim 12, wherein the light-uniforming element is an integration rod or a lens array.

16. The projection method of the projection system according to claim 15, wherein an area of the light incident terminal of the integration rod is greater than or equal to an area of the light emitting terminal
